(19) United States
(12) Patent Application Publication
(10) Pub. No.: US 2025/0366410 A1
(43) Pub. Date: Dec. 4, 2025

(54) AIR-CIRCULATING APPARATUS

(71) Applicant: Sachin Aggarwal, PUNE (IN)

(72) Inventors: Sachin Aggarwal, PUNE (IN); Sankalp Pandey, PUNE (IN)

(21) Appl. No.: 19/221,805

(22) Filed: May 29, 2025

(30) Foreign Application Priority Data
May 29, 2024 (IN) 202421041769
May 27, 2025 (IN) 202523051016

(51) Int. Cl. A01G 9/02; F04D 25/08

(52) U.S. Cl. CPC A01G 9/0302; F04D 25/08

(57) ABSTRACT

The present invention provides an air-circulating apparatus 500 for a pot. The air-circulating apparatus 500 comprises a baseplate 510, a rotating assembly 520, a rotatable mount 530, a stationary mount 560, and a plurality of blades 540. The base plate 510 has a mounting assembly 512. The rotating assembly 520 is coupled on the base plate 510. The rotatable mount 530 is rotatably coupled around the mounting assembly 520 on the base plate 510 and rotatable by the rotating assembly 520 around the mounting assembly 530 along a direction of rotation (R). The rotatable mount 530 comprises a plurality of mounting structures 532. The stationary mount 560 is coupled to the mounting assembly 512.

### FIELD OF INVENTION

This invention relates to indoor plants multiplying health benefits to human being and increasing their life span, and more specifically, relates a rotating plant pot with blades or fins for stirring the air of the surrounding environment near the plant for circulating air from one direction to another direction.

### BACKGROUND OF THE INVENTION

Plants poses various health benefits to human being. Indoor plants are special plants which are kept in low light indoor conditions to provide the same or similar benefits as outdoor plants which includes—Fresh air, Purification of area, cooling effect, adds colors and greenery, beauty and aesthetic value addition to spaces, vastu benefits etc. Plant breathes and provide us Oxygen (day or night or both depends on plant type) and Oxygen is essential for us. Research suggests that air surrounding the plant should be moved or changed to get the most benefit from it. Plants who breathe their own exhaled air, get sick faster (dies) and does not provide the intended benefit. It is common to understand that we should provide ventilation to plant and air should by churned or stirred around it replacing the air with new one (air changes).

There have been some solutions wherein pot carrying the plants are changed from one place to another place in house, for example, from a room to a balcony, to provide fresh air to the plants for its proper growth or for maintaining or improving its conditions for sustaining the plant life. However, it is not always practical solution to change the pot with the plants from one place to another place in house and in timely manner for providing the fresh air to the plant. Therefore, churning air for indoor plants have also been done by home appliances like using ceiling fan, other types of room fan, special location placement where air moves naturally. However, all the existing solutions are costly, needs a lot of additional sources of energy, non practical to provide in some cases, bulky using one more equipment, not necessarily effective as they are general room ventilation devices etc.

Conventionally, there are also such pots that also have features that enables the pot to rotate either manually or automatically. In manually rotatable pot, the pot is rotated manually to ensure that all sides of the plant receive even air changes. In automatic rotating pots, a motorized or automated rotation system is present that slowly turns the pot throughout the day and night. The primary purpose of the rotating pot is to ensure that all parts of the plant receive an adequate amount of air changes. This is especially useful for indoor plants or those in areas with limited natural air. Rotating pots often have a sleek and modern outlook, adding an aesthetic element to indoor or outdoor spaces. Some are even curated to serve as decorative pieces. Rotating pots come in different sizes and materials to accommodate various types of plants and aesthetic preferences. They are preferably made from materials such as plastic, ceramic, or even lightweight metals. Like traditional pots, rotating pots typically have adequate drainage to prevent waterlogging and promote a healthy root system. Rotating pots are generally used for a variety of plants, including flowers, herbs, or small vegetables. Automatic rotating pots require a power source, usually in the form of batteries or an electrical outlet. Overall, rotating pots for plants offer an innovative way to address the challenge of air changes, ensuring that your plants receive the air they need for optimal growth and visual appeal. Further, such, conventional rotating pots generally fail to provide efficient ventilation to the plants configured in the pot, which is essential for plant growth and nourishment.

Moreover, air around the plants always provide cooling effect due to moisture in soil which also provides a better cooling effect in surrounding area. Moving air from the plant can even drop or maintain the temperature of room giving a cooling effect.

Therefore, there is a requirement of a plant pot that may be capable of stirring the air of the surrounding environment near the plant. Furthermore, there is also a requirement of a rotating pot with a proper ventilation mechanism configured in the rotating pot that may provide an adequate amount of fresh air to the plant which is essential for plant growth and nourishment. There is also a demand of effective solution which is built around plants to work on their personal benefits, provides maximum listed benefits, works on no or low energy source, should be cost effective, easy to handle, small in size, should add aesthetic value to place etc.

### SUMMARY OF THE INVENTION

In view of the foregoing disadvantages inherent in the prior art, the general purpose of the present disclosure is to provide a rotating pot carrying the fins or blades to stir the surrounding air near the plant, to overcome the drawbacks inherent in the prior art.

Some of the objects of the present disclosure, which at least one embodiment herein satisfies, are as follows:

An object of the present disclosure is to ameliorate one or more problems of the prior art or to at least provide a useful alternative.

An object of the present disclosure is to provide a rotating pot.

Another object of the present disclosure is to provide a rotating pot for a plant, that can stir air around the plant.

Other objects and advantages of the present disclosure will be more apparent from the following description, which is not intended to limit the scope of the present disclosure.

In an aspect, the present invention provides a rotating pot. In an aspect, the present disclosure provides a rotating pot. The rotating pot for stirring the air of the surrounding environment near the plant comprises a first base, a structure, an inner pot, an annular rotating mechanism, and an annular fan arrangement.

The first base is defined by a base plate having a first centre, a first outer periphery, and a first wall rising from the first outer periphery.

The structure has a structural wall, a top surface and a bottom surface. The bottom surface of the structure is detachably attached to the first centre.

The inner pot is defined by a second base, a second wall rising from the second base to form an enclosed space for placing the plant in the inner pot. The second base is detachably attached to the top surface of the structure.

The annular rotating mechanism is secured on the first base and around the structure. The annular rotating mechanism is configured to rotate an object placed on the annular rotating mechanism.

The annular fan arrangement is defined by a shell having an outer surface, an open top and an open bottom, and a plurality of blades detachably attached to the outer surface. The annular fan arrangement is secured on the annular rotating mechanism and around the inner pot.

The annular fan arrangement is configured to be rotated by the annular rotating mechanism, such that the inner pot is stationary and the annular fan arrangement is rotating to stir air around the rotating pot carrying the plant.

The annular rotating mechanism is selected from a first mechanism, a second mechanism and a third mechanism.

In an embodiment, the annular rotating mechanism is the first mechanism. The first mechanism comprises a ball-bearing assembly, a rotating facilitator and a plurality of first-motored gears. The ball-bearing assembly is fixedly coupled around the structure to the structural wall. The rotating facilitator has a plurality of spur gears. The rotating facilitator is coupled to the ball bearing assembly The annular fan arrangement is detachably attached to the rotating facilitator. The plurality of first-motored gears secured on the first base rotatably coupled to the spur gear of the rotating facilitator. wherein the motor assembly is configured to rotate the rotating facilitator which leads to the rotation of the annular fan arrangement.

In another embodiment, the annular rotating mechanism is the second mechanism. The second mechanism comprises a plurality of second-motored gears and a geared ring. The plurality of second-motored gears is secured on the first base around the structure. The geared ring is rotatably secured over the plurality of second-motored gears. The annular fan arrangement is detachably attached to the geared ring and the plurality of second-motored gears is configured to rotate the geared ring and the annular fan arrangement coupled to the geared ring.

In yet another embodiment, the annular rotating mechanism is the third mechanism. The third mechanism comprises a plurality of motored rollers and an inverted cone disk. The plurality of motored rollers secured on the first base. The inverted cone disk is secured over the motored rollers and coupled to the annular fan arrangement. The motored rollers are configured to rotate the inverted cone disk and the annular fan arrangement is coupled to the inverted con disk.

Each blade of the plurality of blades is defined by a pair of long edges and a pair of short edges. The plurality of blades is selected type-1 blades, type-2 blades, type-3 blades, type-4 blades, type-5 blades and type-6 blades. The type-1 blades are curved towards the middle and concaving along the long and short edges, the type-1 blades are inclined towards backward direction. The type-2 blades are concaving along long edges. The type-3 blades are wide towards the top and narrow towards the bottom of the blades with tapered edges, and the type-3 blades are concaving along long edges. The type-4 blades are curved along the short edges. The type-5 blades are curved along the long edges, and the type-5 blades are inclined towards backward direction. the type-6 blades are wide towards the top and narrow towards the bottom of the blades with tapered edges, and the type-6 blades are concaving along long edges towards the top of the blades.

In another aspect, the rotating pot further comprises a photovoltaic panel rim placed over the second wall. The photovoltaic panel rim is configured to supply power to the annular rotating mechanism.

In an embodiment, the inner pot comprises a battery holder to hold one or more batteries to supply power to the annular rotating mechanism.

The structure has a shape selected from cylinder, prism, cuboid, slab, or inverted frustum. In a preferred embodiment, the shape of the structure is the cylinder.

In another aspect, the rotating pot further comprises a photovoltaic panel rim placed over the second wall. The photovoltaic panel rim is configured to supply power to the annular rotating mechanism.

In an embodiment, the inner pot comprises a battery holder to hold one or more batteries to supply power to the annular rotating mechanism.

The structure has a shape selected from cylinder, prism, cuboid, slab, or inverted frustum. In a preferred embodiment, the shape of the structure is the cylinder.

In another aspect, the present disclosure provides an air-circulating apparatus for a pot. The air-circulating apparatus comprises a baseplate, a rotating assembly, a rotatable mount, a stationary mount, and a plurality of blades.

The base plate has a mounting assembly. The rotating assembly is coupled on the base plate. The rotatable mount is rotatably coupled around the mounting assembly on the base plate and rotatable by the rotating assembly around the mounting assembly along a direction of rotation. The rotatable mount comprises a plurality of mounting structures. The stationary mount is coupled to the mounting assembly.

The rotatable mount comprises a plurality of mounting structures.

Each blade of the plurality of blades is coupled to a respective mounting structure of the plurality of mounting structures to extend upwardly from the rotatable mount and be rotatable with the rotatable mount.

In an embodiment, each of the plurality of mounting structures comprises a slot arrangement to mount the blades.

In an embodiment, each blade comprises a coupling end and a blade profile. The coupling end is detachably coupled to the mounting structures. The blade profile extends upwardly from the coupling end, wherein the blade profile of the blade is configured to create air turbulence when the plurality of blades rotates along with the rotatable mount. The blade profile comprises a helically curved profile having a concave side facing in the direction of rotation. The helically curved profile is slanted in a direction opposite to the direction of rotation.

In an embodiment, the rotating assembly comprises a motor member and a plurality of motor gears. The plurality of motor gears is coupled to the motor member, wherein the plurality of motor gears is rotatably coupled with a plurality of mount gears of the rotatable mount to rotate the rotatable mount.

In an embodiment, the air-circulating apparatus further comprises a power source coupled to the rotating assembly to operate the motor member.

The air-circulating apparatus further comprises a control unit communicably coupled to the rotating assembly to control the speed of the motor member.

In an embodiment, the air-circulating apparatus further comprises a coupling plate to receive the rotating assembly thereon, wherein the coupling plate is coupled to the base plate.

In an embodiment, the base plate further comprises a boundary wall extending upwardly from a periphery of the base plate. The boundary wall defines an space with the mounting assembly, whereby the rotatable mount is detachably and rotatably secured.

In an embodiment, the base plate further comprises a plurality of legs provided at the bottom in the leg mount of the base plate.

In an embodiment, the rotatable mount is rotatably coupled around the mounting assembly via a bearing. The bearing member has an inner profile and an outer profile coupled to each other with a plurality of balls. The inner profile is engaged to the mounting assembly, and the outer profile is engaged to the rotatable mount to be rotatably coupled around the mounting assembly.

In an embodiment, the air-circulating apparatus further comprises a peripheral protrusion on the mounting assembly to support the bearing member.

In an embodiment, the pot is placed on the mounting assembly.

In an embodiment, the air-circulating apparatus further comprises a stationary mount coupled to the mounting assembly, wherein the pot is placed on the stationary mount.

In an embodiment, the stationary mount has a complimentary mounting assembly and a platform member. The complimentary mounting assembly is to be coupled with the mounting assembly of the base plate. The platform member is provided above the complimentary mounting assembly mounting assembly to receive the pot thereon.

In an embodiment, the stationary mount is a pot assembly having a pot complimentary mounting assembly to be coupled with the mounting assembly of the base plate.

### BRIEF DESCRIPTION OF DRAWING

The foregoing summary, as well as the following detailed description of various embodiments, is better understood when read in conjunction with the drawings provided herein. For the purposes of illustration, there are shown in the drawings exemplary embodiments; however, the presently disclosed subject matter is not limited to the specific rotating pot and instrumentalities disclosed.

FIG. 1 illustrates a perspective view of a rotating pot, according to an aspect of the present disclosure;

FIG. 2 illustrates an exploded view of the rotating pot, according to an embodiment of the present disclosure;

FIG. 3A, FIG. 3B and FIG. 3C illustrate different types of mechanisms of an annular rotating mechanism for the rotating pot, according to an embodiment of the present disclosure;

FIG. 4 illustrates an exploded view of a first mechanism of the annular rotating mechanism for the rotating pot, according to an embodiment of the present disclosure;

FIG. 5 illustrates an exploded view of a second mechanism of the annular rotating mechanism for the rotating pot, according to an embodiment of the present disclosure;

FIG. 6 illustrates an exploded view of a third mechanism of the annular rotating mechanism for the rotating pot, according to an embodiment of the present disclosure;

FIG. 7A, FIG. 7B, FIG. 7C, FIG. 7D, FIG. 7E and FIG. 7F illustrate different types of blades used in the rotating pot, according to an aspect of the present disclosure;

FIG. 8 illustrates a side view of the air-circulating apparatus for a pot, according to an aspect of the present disclosure;

FIG. 9 illustrates a top view of a base plate of the air-circulating apparatus, according to an embodiment of the present disclosure;

FIG. 10 illustrates a top view of a rotatable mount of the air-circulating apparatus for a pot, according to an embodiment of the present disclosure;

FIG. 11 illustrates a bottom view of a rotatable mount of the air-circulating apparatus, according to an embodiment of the present disclosure;

FIG. 12 illustrates a bottom view of a rotatable mount, wherein a plurality of mount gears is rotatably coupled to the motor gear, according to an embodiment of the present disclosure;

FIG. 13 illustrates a bearing of the air-circulating apparatus, according to an embodiment of the present disclosure;

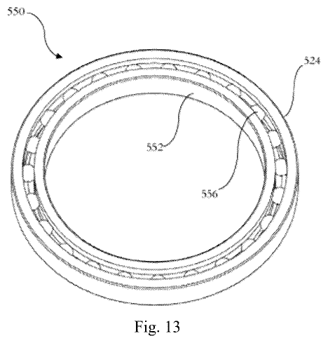

FIG. 14 illustrates a plurality of blades of the air-circulating apparatus, according to an embodiment of the present disclosure;

FIG. 15 illustrates a cross-sectional view of the air-circulating apparatus, according to an embodiment of the present disclosure;

FIG. 16 illustrates an exploded view of the air-circulating apparatus, according to an embodiment of the present disclosure; and

FIG. 17 illustrates a pot assembly as a stationary mount of the air-circulating apparatus, wherein the pot is to be coupled with the mounting assembly, according to an embodiment of the present disclosure.

Like reference numerals refer to like parts throughout the description of several views of the drawing.

### DETAILED DESCRIPTION

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open-ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The following detailed description should be read with reference to the drawings, in which similar elements in different drawings are identified with the same reference numbers. The drawings, which are not necessarily to scale, depict illustrative embodiments and are not intended to limit the scope of the disclosure.

It is to be understood that both the foregoing general description and the following detailed description are exemplary and explanatory only and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements or components that comprise more than one unit unless specifically stated otherwise.

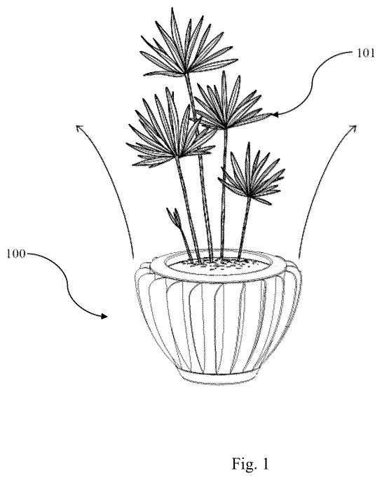

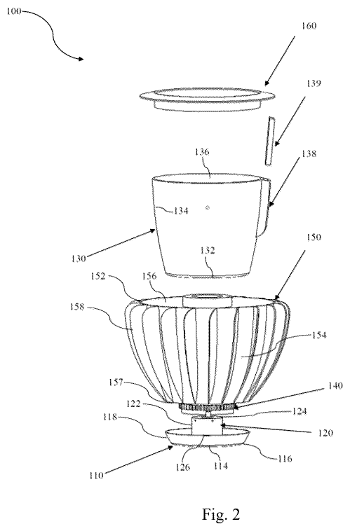

In an aspect, the present invention provides a rotating pot. As illustrated in FIG. 1 and FIG. 2, the rotating pot 100 for a plant 101 to stir the air of the surrounding environment near the plant 101 comprises a first base 110, a structure 120, an inner pot 130, an annular rotating mechanism 140, and an annular fan arrangement 150.

The first base 110 is defined by a base plate 112 having a first centre 114, a first outer periphery 116, and a first wall 118 rising from the first outer periphery 116.

The structure 120 has a structural wall 122, a top surface 124 and a bottom surface 126. The bottom surface 126 of the structure 120 is detachably attached to the first centre 114.

The inner pot 130 is defined by a second base 132, a second wall 134 rising from the second base 132 to form an enclosed space 136 for placing the plant 101 in the inner pot 130. The second base 132 is detachably attached to the top surface 124 of the structure 120.

The annular rotating mechanism 140 is secured on the first base 110 and around the structure 120. The annular rotating mechanism 140 is configured to rotate an object placed on the annular rotating mechanism 140.

The annular fan arrangement 150 is defined by a shell 152 having an outer surface 154, an open top 156 and an open bottom 157, and a plurality of blades (or fins) 158 detachably attached to the outer surface 154. The annular fan arrangement 150 is secured on the annular rotating mechanism 140 and around the inner pot 130.

The annular fan arrangement 150 is configured to be rotated by the annular rotating mechanism 140, such that the inner pot 130 is stationary and the annular fan arrangement 150 is rotating to stir the air around the rotating pot 100 carrying the plant 101. During rotation, the annular fan arrangement 150 is configured to stir the air of the surrounding environment near the rotating pot 100 carrying the plant 101.

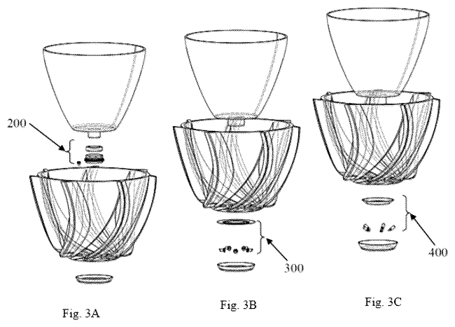

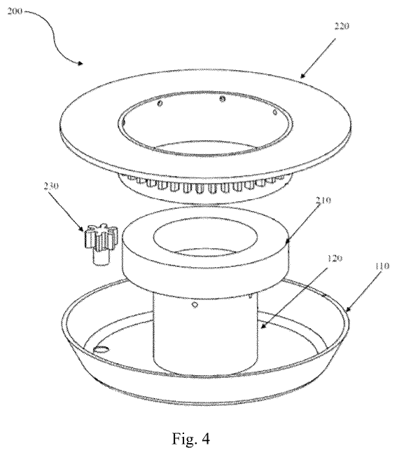

As illustrated in FIG. 3A, FIG. 3B and FIG. 3C, the annular rotating mechanism 140 is selected from a first mechanism 200, a second mechanism 300 and a third mechanism 400 as described herein below in conjunction with FIGS. 4, 5 and 6.

In an embodiment, the annular rotating mechanism 140 is the first mechanism 200. As illustrated in FIG. 4, the first mechanism 200 comprises a ball-bearing assembly 210, a rotating facilitator 220 and a plurality of first-motored gears 230. The ball bearing assembly 210 is fixedly coupled around the structure 120 to the structural wall 122. The rotating facilitator 220 has a plurality of spur gears. The rotating facilitator 220 is coupled to the ball bearing assembly 210 The annular fan arrangement 150 is detachably attached to the rotating facilitator 220. The plurality of first-motored gears 230 secured on the first base 110 rotatably coupled to the spur gear of the rotating facilitator 220, wherein the motor assembly 122 is configured to rotate the rotating facilitator 220 which leads to the rotation of the annular fan arrangement 150.

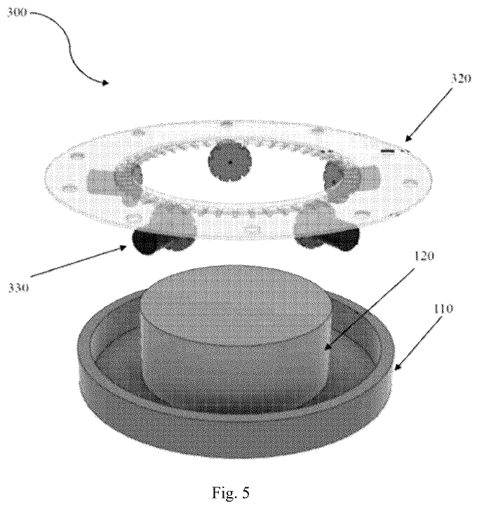

In another embodiment, as illustrated in FIG. 5, the annular rotating mechanism 140 is the second mechanism 300. The second mechanism 300 comprises a plurality of second-motored gears 310 and a geared ring 320. The plurality of second-motored gears 310 is secured on the first base 110 around the structure 120. The geared ring 320 is rotatably secured over the plurality of second-motored gears 310. The annular fan arrangement 150 is detachably attached to the geared ring 320 and the plurality of second-motored gears 310 is configured to rotate the geared ring 320 and the annular fan arrangement 150 coupled to the geared ring 320.

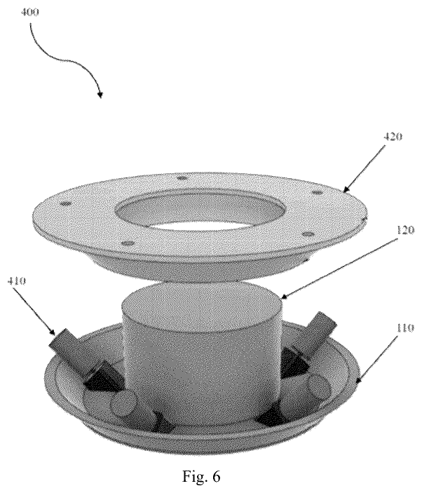

In yet another embodiment, as illustrated in FIG. 6, the annular rotating mechanism 140 is the third mechanism 400. The third mechanism 400 comprises a plurality of motored rollers 410 and an inverted cone disk 420. The plurality of motored rollers 410 secured on the first base 110. The inverted cone disk 420 is secured over the motored rollers 410 and coupled to the annular fan arrangement 150. The motored rollers 410 are configured to rotate the inverted cone disk 420 and the annular fan arrangement 150 coupled to the inverted con disk 420.

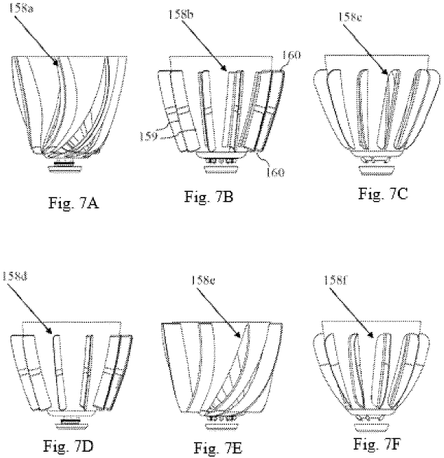

As illustrated in FIG. 7A, FIG. 7B, FIG. 7C, FIG. 7D, FIG. 7E, and FIG. 7F, each blade of the plurality of blades is defined by a pair of long edges and a pair of short edges. The plurality of blades 158 is selected from type-1 blades 158a, type-2 blades 158b, and type-3 blades 158c, type-4 blades 158d, type-5 blades 158e, and type-6 blades 158f.

In an embodiment, as illustrated in FIG. 7A, the type-1 blades 158a are curved towards the middle and concaving along the long and short edges, the type-1 blades 158a are inclined towards backward direction.

In an embodiment, as illustrated in FIG. 7B, the type-2 blades 158b are concaving along long edges.

In an embodiment, as illustrated in FIG. 7C, the type-3 blades 158c are wide towards the top and narrow towards the bottom of the blades with tapered edges, and the type-3 blades 158c are concaving along long edges.

In an embodiment, as illustrated in FIG. 7D, the type-4 blades 158d are curved along the short edges.

In an embodiment, as illustrated in FIG. 7E, the type-5 blades 158e are curved along the long edges, and the type-5 blades 158e are inclined towards backward direction.

In an embodiment, as illustrated in FIG. 7F, the type-6 blades 158f are wide towards the top and narrow towards the bottom of the blades with tapered edges, and the type-6 blades 158f are concaving along long edges towards the top of the blades.

In another aspect, as illustrated in FIG. 2, the rotating pot further comprises a photovoltaic panel rim 160a placed over the second wall 134. The photovoltaic panel rim 160a is configured to supply power to the annular rotating mechanism 140.

In an embodiment, the inner pot 130 comprises a battery holder 138 to hold one or more batteries 139 to supply power to the annular rotating mechanism 140.

The structure 120 has a shape selected from cylinder, prism, cuboid, slab, or inverted frustum. In a preferred embodiment, the shape of the structure 120 is the cylinder.

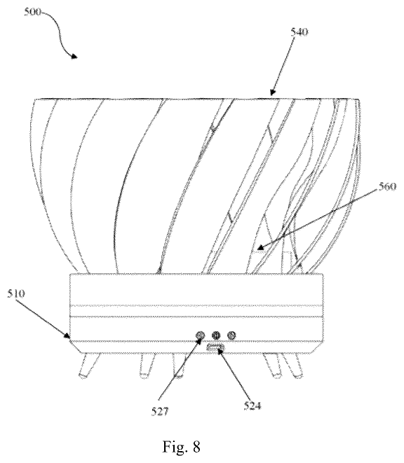

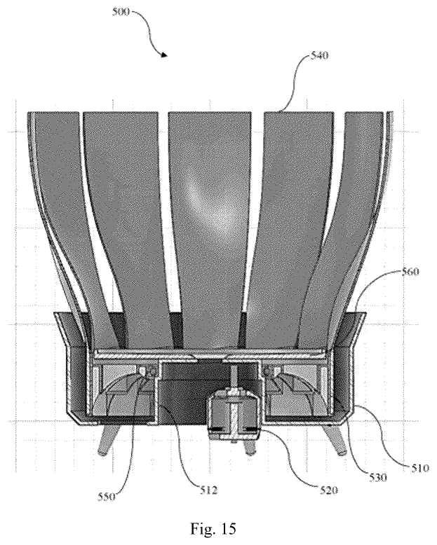

In another aspect, as illustrated in FIGS. 8, 15, and 16, the present disclosure provides an air-circulating apparatus 500 for a pot. The air-circulating apparatus 500 comprises a baseplate 510, a rotating assembly 520, a rotatable mount 530, a stationary mount 560, and a plurality of blades 540.

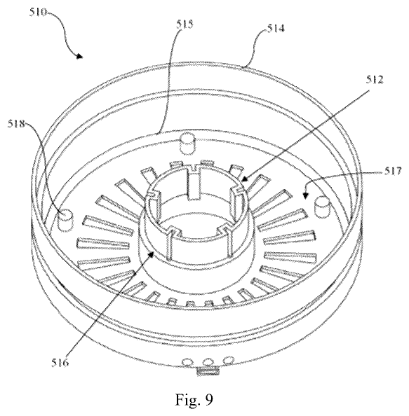

As illustrated in FIG. 9, the base plate 510 has a mounting assembly 512. The rotating assembly 520 is coupled on the base plate 510. The rotatable mount 530 is rotatably coupled around the mounting assembly 520 on the base plate 510 and rotatable by the rotating assembly 520 around the mounting assembly 530 along a direction of rotation (R). The rotatable mount 530 comprises a plurality of mounting structures 532. The stationary mount 560 is coupled to the mounting assembly 512.

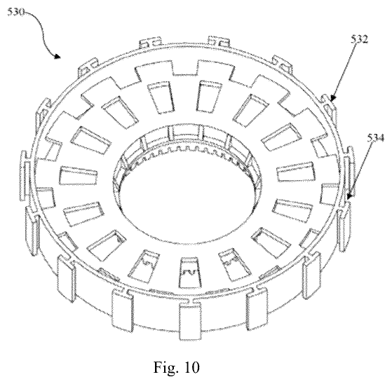

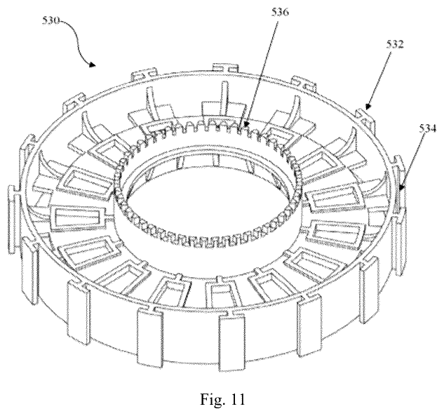

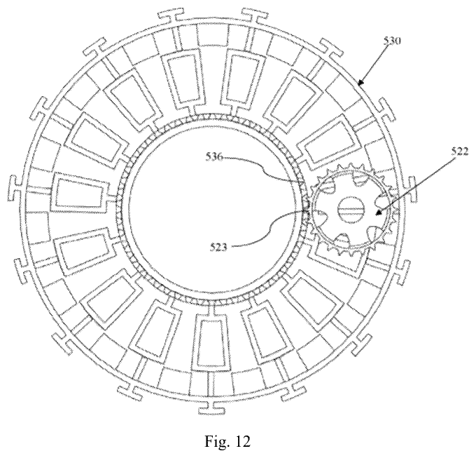

As illustrated in FIGS. 10, 11 and 12, the rotatable mount 530 comprises a plurality of mounting structures 532. The mounting structures are T-shaped fins present at the perimeter of the mounting structures 532, wherein two consecutive fins form a slot. Such sequential slots are called the slot arrangement 534.

Further, in an embodiment, each of the base plate and the mounting assembly may include one or more recessed structures to keep the mounting assembly robust yet light weight. Such recessed structures may also be used as heat decapitating medium to release heat generated by the rotating assembly.

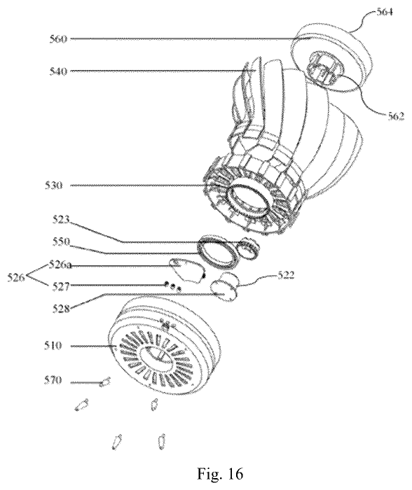

As illustrated in FIG. 16, each blade of the plurality of blades 540 is coupled to a respective mounting structure 532 of the plurality of mounting structures 532 to extend upwardly from the rotatable mount 530 and be rotatable with the rotatable mount 530.

In an embodiment, as illustrated in FIGS. 10, 11 and 12, each of the plurality of mounting structures 532 comprises a slot arrangement 534 to mount the blades 540.

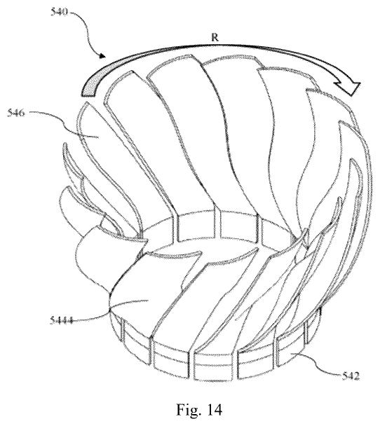

In an embodiment, as illustrated in FIG. 14, each blade 540 comprises a coupling end 542 and a blade profile 544. The coupling end 542 to be detachably coupled to the mounting structures 532. The blade profile 544 extends upwardly from the coupling end 542, wherein the blade profile 544 of the blade 540 is configured to create air turbulence when the plurality of blades 540 rotates along with the rotatable mount 530. The blade profile 544 comprises a helically curved profile having a concave side 546 facing in the direction of rotation (R). The helically curved profile 544 is slanted in a direction opposite to the direction of rotation (R). The direction of rotation (R) is clockwise in one embodiment. The direction of rotation (R) is anti-clockwise in another embodiment.

In an embodiment, as illustrated in FIGS. 8, 12, 15 and 16, the rotating assembly 520 comprises a motor member 522 and a plurality of motor gears (523). The plurality of motor gears (523) is coupled to the motor member 522, wherein the plurality of motor gears (523) is rotatably coupled with a plurality of mount gears 536 of the rotatable mount 530 to rotate the rotatable mount 530.

In an embodiment, as illustrated in FIG. 8, the air-circulating apparatus 500 further comprises a power source 524 coupled to the rotating assembly 520 to operate the motor member 522.

As illustrated in FIG. 16, the air-circulating apparatus 500 further comprises a control unit 526 communicably coupled to the rotating assembly 520 to control the speed of the motor member 522. The control unit 526 may include a processor 526a to operate the motor member 522 based on input from one or more switches 527. The switches 527 are electrically coupled to the processor 526a, and based on the input provides by the switches 527, the processor 526a operates the rotating assembly 520 or the motor member 522. For example, one or more switches may include a ON/OFF switch to start and stop the air circulating apparatus 500. One or more switches 527 may also include speed regulation switches to increase or decrease speed of the air circulating apparatus 500.

In an embodiment, as illustrated in FIG. 16, the air-circulating apparatus 500 further comprises a coupling plate (528) to receive the rotating assembly 520 thereon, wherein the coupling plate (528) is coupled to the base plate. In one example, the coupling plate (528) and the rotating assembly 520 may be a two-unit arrangement, whereby the coupling plate (528) mat be first coupled to a top surface of the base plate, and, further, the rotating assembly 520 is coupled on the coupling plate. In another example, the coupling plate (528) and the rotating assembly 520 may be single-unit arrangement to be coupled together to the top surface of the base plate.

In an embodiment, as illustrated in FIG. 9, the base plate 510 further comprises a boundary wall 514 extending upwardly from a periphery 515 of the base plate 510. The boundary wall 514 defines a space 517 with the mounting assembly 512, whereby the rotatable mount 530 is detachably and rotatably secured.

In an embodiment, the base plate 510 further comprises a plurality of legs 570 provided at a bottom surface of the base plate 510. The plurality of legs 517 is attached to the bottom surface of the base plate 510 by a plurality of leg mount 518. The plurality of leg mounts 518 extends upwardly from the top surface of the base plate 510 such that each leg mount 518 defines a hole extending from the bottom surface to receive the legs 570.

In an embodiment, the rotatable mount 530 is rotatably coupled around the mounting assembly 512 via a bearing 550. The bearing member 550 has an inner profile (552) and an outer profile 554 coupled to each other with a plurality of balls 556. The inner profile (552) is engaged to the mounting assembly 512, and the outer profile 554 is engaged to the rotatable mount 530 to be rotatably coupled around the mounting assembly 512.

In an embodiment, the air-circulating apparatus 500 further comprises a peripheral protrusion 516 across the outer surface of the mounting assembly 512 to support the bearing member 550 thereon.

Referring to FIG. 16, the stationary mount 560 is adapted to be mounted with the mounting assembly 512. In an embodiment, the stationary mount 560 includes a complimentary mounting assembly (562) and a platform member 564. The complimentary mounting assembly (562) is adapted to be coupled with the mounting assembly 512 of the base plate 510. Further, the platform member 564 is provided above the complimentary mounting assembly (562) to receive a pot thereon.

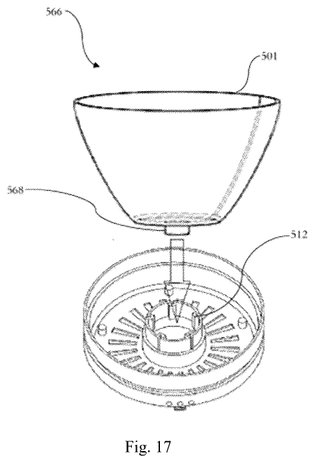

In another embodiment, as illustrated in FIG. 17, the stationary mount 560 is itself a pot 501 assembly 566 having a complimentary mounting assembly 568 to be coupled directly with the mounting assembly 512 of the base plate 510.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

### LIST OF REFERENCE NUMERALS

| | |
|---|---|
| 100 | Rotating pot |
| 101 | Plant |
| 110 | First base |
| 112 | Base plate |
| 114 | First centre |
| 116 | First outer periphery |
| 118 | First wall |
| 120 | Structure |
| 122 | Structural wall |
| 124 | Top surface |
| 126 | Bottom surface |
| 130 | Inner pot |
| 132 | Second base |
| 134 | Second wall |
| 136 | Enclosed space |
| 140 | Annular rotating mechanism |
| 150 | Annular fan arrangement |
| 152 | Shell |
| 154 | Outer surface of shell |
| 156 | Open top |
| 157 | Open bottom |
| 158 | Blades on the outer surface |
| 158a | Type-1 blades |
| 158b | Type-2 blades |
| 158c | Type-3 blades |
| 158d | Type-4 blades |
| 158e | Type-5 blades |
| 158f | Type 5 blades |
| 159 | Pair of long edges |
| 160 | Pair of short edges |
| 200 | First mechanism of annular rotating |
| | mechanism |
| 210 | Ball bearing assembly |
| 220 | Rotating facilitator |
| 230 | First-motored gears |
| 300 | Second mechanism |
| 310 | Second-motored gears |
| 320 | Geared ring |
| 400 | Third mechanism |
| 410 | Motored rollers |
| 420 | Inverted cone disk |
| 160a | Photovoltaic panel rim |
| 138 | Battery holder |
| 139 | Batteries |
| 500 | Air-circulating apparatus |
| 501 | Pot |
| 510 | Base plate |
| 512 | Mounting assembly |
| 514 | Boundary wall |
| 515 | Periphery |
| 516 | Peripheral protrusion |
| 517 | Space |
| 518 | Leg mount |
| 520 | Rotating assembly |
| 522 | Motor member |
| 523 | Motor gear |
| 524 | Power source |
| 526 | Control unit |
| 526a | Processor |
| 527 | Switches |
| 528 | Coupling plate |
| 530 | Rotatable mount |
| 532 | Mounting structures |
| 534 | Slot arrangement |
| 536 | Mount gear |
| 540 | Blades |
| 542 | Coupling end |
| 544 | Blade profile |
| 546 | Concave side |
| R | Direction of rotation |
| 550 | Bearing |
| 552 | Inner profile |
| 554 | Outer profile |
| 556 | Plurality of balls |
| 560 | Stationary mount |
| 562 | Complimentary mounting assembly |
| 564 | Platform member |
| 566 | Pot assembly |
| 568 | Pot complimentary mounting assembly |
| 570 | Legs |

What is claimed is:

1. An air-circulating apparatus for a pot, the air-circulating apparatus comprising:
a base plate having a mounting assembly;
a rotating assembly coupled on the base plate;
a rotatable mount rotatably coupled around the mounting assembly on the base plate and rotatable by the rotating assembly around the mounting assembly along a direction of rotation, wherein the rotatable mount comprises a plurality of mounting structures;
a stationary mount coupled to the mounting assembly;
a plurality of blades, wherein each blade of the plurality of blades is coupled to a respective mounting structure of the plurality of mounting structures to extend upwardly from the rotatable mount and be rotatable with the rotatable mount.

2. The air-circulating apparatus as claimed in claim 1, wherein each of the plurality of mounting structures comprises a slot arrangement to mount the blades.

3. The air-circulating apparatus as claimed in claim 1, wherein each blade comprises:
a coupling end to be detachably coupled to the mounting structures;
a blade profile extends upwardly from the coupling end, wherein the blades profile of the blade is configured to create air turbulence when the plurality of blades rotates along with the rotatable mount.

4. The air-circulating apparatus as claimed in claim 3, wherein the blade profile comprises a helically curved profile having a concave side facing in the direction of rotation.

5. The air-circulating apparatus as claimed in claim 4, wherein the helically curved profile is slanted in a direction opposite to the direction of rotation.

6. The air-circulating apparatus as claimed in claim 1, wherein the rotating assembly comprises:
a motor member;
a plurality of motor gears coupled to the motor member, wherein the plurality of motor gears is rotatably coupled with a plurality of mount gears of the rotatable mount to rotate the rotatable mount.

7. The air-circulating apparatus as claimed in claim 6 further comprising:
a power source coupled to the rotating assembly to operate the motor member.

8. The air-circulating apparatus as claimed in claim 6 further comprising:
a control unit communicably coupled to the rotating assembly to control the speed of the motor member.

9. The air-circulating apparatus as claimed in claim 1 further comprising:
a coupling plate to receive the rotating assembly thereon, wherein the coupling plate is coupled to the base plate.

10. The air-circulating apparatus as claimed in claim 1, wherein the base plate further comprises:
a boundary wall extending upwardly from a periphery of the base plate, wherein the boundary wall defines a space with the mounting assembly whereby the rotatable mount is detachably and rotatably secured.

11. The air-circulating apparatus as claimed in claim further comprising:
a plurality of legs provided at a bottom of the base plate.

12. The air-circulating apparatus as claimed in claim 1 further comprising a bearing member having an inner profile and an outer profile coupled to each other a plurality of balls, wherein the inner profile is engaged to the mounting assembly and the outer profile is engaged to the rotatable mount to be rotatably coupled around the mounting assembly.

13. The air-circulating apparatus as claimed in claim 12 further comprising:
a peripheral protrusion on the mounting assembly to support the bearing member.

14. The air-circulating apparatus as claimed in claim 1, wherein the stationary mount having:
a complimentary mounting assembly to be coupled with the mounting assembly of the base plate; and
a platform member provided above the complimentary mounting assembly to receive the pot thereon.

15. The air-circulating apparatus as claimed in claim 1, wherein the stationary mount is a pot assembly having a complimentary mounting assembly to be coupled with the mounting assembly of the base plate.

16. A rotating pot for a plant to stir the air of the surrounding environment near the plant, the rotating pot comprising:
a first base 110 defined by a base plate having a first centre, a first outer periphery, and a first wall rising from the first outer periphery;
a structure having a structural wall, a top surface and a bottom surface, wherein the bottom surface of the structure is detachably attached to the first centre, wherein the structure has a shape selected from cylinder, prism, cuboid, slab, or inverted frustum;
an inner pot defined by a second base, a second wall rising from the second base to form an enclosed space for placing the plant in the inner pot, the second base is detachably attached to the top surface of the structure, wherein the inner pot comprises a battery holder to hold one or more batteries to supply power to the annular rotating mechanism;
an annular rotating mechanism secured on the first base and around the structure, wherein the annular rotating mechanism is selected from a first mechanism, a second mechanism and a third mechanism; and
an annular fan arrangement defined by a shell having an outer surface, an open top and an open bottom, and a plurality of blades detachably attached to the outer surface, the annular fan arrangement is secured on the annular rotating mechanism and around the inner pot, wherein during rotation the annular fan arrangement is configured to stir the air of the surrounding environment near the plant,
wherein the annular fan arrangement is configured to be rotated by the annular rotating mechanism, such that the inner pot is stationary and the annular fan arrangement is rotating to stir the air around the rotating pot near the plant.

17. The rotating pot as claimed in claim 1, wherein the annular rotating mechanism is selected from a first mechanism, a second mechanism and a third mechanism, wherein:
the first mechanism comprises:
a ball bearing assembly fixedly coupled around the structure to the structural wall;
a rotating facilitator having a plurality of spur gears, the rotating facilitator is coupled to the ball bearing assembly, wherein the annular fan arrangement is detachably attached to the rotating facilitator; and
a plurality of first-motored gears secured on the first base rotatably coupled to the spur gear of the rotating facilitator, wherein the motor assembly is configured to rotate the rotating facilitator that led to the rotation of the annular fan arrangement,
the second mechanism comprises:
a plurality of second-motored gears secured on the first base around the structure; and
a geared ring rotatably secured over the plurality of second-motored gears, wherein the annular fan arrangement is detachably attached to the geared ring and the plurality of second-motored gears is configured to rotate the geared ring and the annular fan arrangement coupled to the geared ring,
the third mechanism comprises:
a plurality of motored rollers secured on the first base;
an inverted cone disk secured over the motored rollers and coupled to the annular fan arrangement, wherein the motored rollers are configured to rotate the inverted cone disk and the annular fan arrangement coupled to the inverted con disk.

18. The rotating pot as claimed in claim 1, wherein each blade of the plurality of blades is defined by a pair of long edges and a pair of short edges, the blades are selected from type-1 blades, type-2 blades, type-3 blades, type-4 blades, type-5 blades, and type-6 blades, wherein:
the type-1 blades are curved towards the middle and concaving along the long and short edges, the type-1 blades are inclined towards backward direction,
the type-2 blades are concaving along long edges,
the type-3 blades are wide towards the top and narrow towards the bottom of the blades with tapered edges, and the type-3 blades are concaving along long edges,
the type-4 blades are curved along the short edges,
the type-5 blades are curved along the long edges, and the type-5 blades are inclined towards backward direction,
the type-6 blades are wide towards the top and narrow towards the bottom of the blades with tapered edges, and the type-6 blades are concaving along long edges towards the top of the blades.

19. The rotating pot as claimed in claim 1 further comprises a photovoltaic panel rim placed over the second wall, wherein the photovoltaic panel rim is configured to supply power to the annular rotating mechanism.
